(19) United States
(12) Patent Application Publication
(10) Pub. No.: US 2017/0305437 A1
(43) Pub. Date: Oct. 26, 2017

(54) CROWD-SOURCED VEHICLE SETTING RECOMMENDATIONS

(71) Applicant: Google Inc., Mountain View, CA (US)

(72) Inventors: Joseph M. Onorato, Cambridge, MA (US); Andrew Scott Brenner, Sunnyvale, CA (US); Daniel Holle, San Francisco, CA (US); Patrick Brady, San Francisco, CA (US)

(21) Appl. No.: 15/494,786

(22) Filed: Apr. 24, 2017

Related U.S. Application Data
(60) Provisional application No. 62/327,703, filed on Apr. 26, 2016.

(51) Int. Cl. B60W 50/00; B60W 50/14; G06N 3/08; G07C 5/08; G06N 3/04; G07C 5/00; H04L 29/08

(52) U.S. Cl. CPC B60W 50/0098; G06N 3/04; B60W 50/14; G06N 3/08; G07C 5/008; G07C 5/08; B60W 2050/146; B60W 2420/42; B60W 2422/90; B60W 2540/28; H04L 67/10; H04L 67/306

(57) ABSTRACT

Driver vehicle setting values are crowd-sourced from multiple users in an anonymous manner. The crowd-sourced driver vehicle setting values are processed using machine learning to generate one or more vehicle setting recommendations to other users. The recommendations may be for vehicle settings that the user has not yet activated or vehicle setting values that are frequently used for a particular vehicle.

### CROSS-REFERENCE TO RELATED APPLICATION

This application claims priority from U.S. Provisional Application No. 62/327,703, filed Apr. 26, 2016, and titled “Crowd-Sourced Vehicle Setting Recommendations,” which is incorporated herein by reference in its entirety.

### FIELD

This disclosure generally relates to automobiles.

### BACKGROUND

Vehicle setting values may be adjusted for a driver when the driver enters the vehicle. For example, a driver may adjust a value of a car seat setting or a value of an ambient temperature setting in a vehicle. Oftentimes when a driver enters a vehicle, the driver may not be aware of one or more vehicle settings that are available to the driver.

### SUMMARY

This disclosure generally describes a system and method for obtaining crowd-sourced vehicle setting data and using machine learning to recommend vehicle setting values for a driver.

According to implementations, driver vehicle setting values are crowd-sourced from multiple users in an anonymous manner. The crowd-sourced driver vehicle setting values are processed using machine learning to generate one or more vehicle setting recommendations to other users. The vehicle setting recommendations may be related to, for example, vehicle settings that the user has not yet activated or vehicle setting values that are popularly used for a particular vehicle.

Innovative aspects of the subject matter described in this specification include, in some implementations, a computer-implemented method to perform actions. The actions include obtaining driver vehicle setting data from a plurality of vehicles, identifying a vehicle model associated with the driver vehicle setting data obtained from the plurality of vehicles, and generating a vehicle setting recommendation for the identified vehicle model based on the driver vehicle setting data obtained from the plurality of vehicles.

Implementations may each optionally include one or more of the following features. For instance, in some implementations, the driver vehicle setting data obtained from the plurality of vehicles includes one or more of mirror positions, a driver seat position, steering wheel position, foot pedal positions, radio station presets, heating, ventilation, air conditioning (HVAC) settings, vehicle lighting preferences, wiper speed settings, navigation settings, camera bumper settings, safety alert settings, child lock settings, and window lock settings.

In some implementations, the driver vehicle setting data obtained from the plurality of vehicles does not include identification information of a driver.

In some implementations, the action of generating the vehicle setting recommendation for the identified vehicle model based on the driver vehicle setting data obtained from the plurality of vehicles includes generating the vehicle setting recommendation using machine learning.

In some implementations, the machine learning comprises training one or more neural networks to determine the vehicle setting recommendation.

In some implementations, the action of obtaining the driver vehicle setting data from the plurality of vehicles includes receiving crowd-sourced driver vehicle setting data from vehicles having the same model as the identified vehicle model. The action of generating the vehicle setting recommendation for the identified vehicle model based on the driver vehicle setting data obtained from the plurality of vehicles includes: 1) determining, according to one or more criteria, a score for a vehicle setting; 2) determining that the score satisfies a particular threshold; and 3) generating the vehicle setting recommendation to recommend the vehicle setting that has the score that satisfies the particular threshold.

In some implementations, the one or more criteria includes one or more of a frequency of use of the vehicle setting, a social network trending popularity of the vehicle setting, a safety rating of the vehicle setting, and a recommendation from a manufacturer of the identified vehicle model.

In some implementations, the action of determining, according to one or more criteria, the score for the vehicle setting included in the driver vehicle setting data includes assigning each of the one or more criteria a weight, and determining the score for the vehicle setting based, in part, on the assigned weights to the one or more criteria.

In some implementations, the actions further include receiving an indication that a driver is within a threshold distance of a second vehicle, determining that a model of the second vehicle matches the identified vehicle model, and transmitting the vehicle setting recommendation to a device associated with the driver within the threshold distance of the second vehicle.

In some implementations, the actions further include generating a plurality of particular driver profiles, and determining that a likely profile of the driver within the threshold distance of the second vehicle matches one of the plurality of particular driver profiles.

In some implementations, the device associated with the driver includes a portable electronic device associated with the driver or a vehicle control module of the second vehicle.

In some implementations, the action of determining that the likely profile of the driver within the threshold distance of the second vehicle matches one of the plurality of particular driver profiles includes determining that one or more of a likely height, a likely arm length, and a likely leg length of the driver within the threshold distance of the second vehicle respectively matches one or more of a likely height, a likely arm length, and a likely leg length in the one of the plurality of particular driver profiles. The vehicle setting recommendation is based at least in part on the likely profile of the driver.

In some implementations, the actions further include receiving an indication that a driver is within a threshold distance of a second vehicle, determining that a model of the second vehicle matches the identified vehicle model, and transmitting the vehicle setting recommendation to a device associated with the driver within the threshold distance of the second vehicle. The one or more criteria includes one or more of an interest of the driver and a vehicle setting preference of the driver. The vehicle setting recommendation includes a recommendation associated with the one or more of the interest of the driver and the vehicle setting preference of the driver.

In some implementations, the actions further include receiving a selection by the driver indicating acceptance of the vehicle setting recommendation.

In some implementations, the selection by the driver indicating acceptance of the vehicle setting recommendation is received from a portable electronic device associated with the driver or a vehicle control module of the second vehicle.

In some implementations, the vehicle setting recommendation includes a recommendation associated with a vehicle setting that has not been activated in the second vehicle.

The above-noted implementations and description below provide several advantages and conveniences for drivers. For example, drivers who are not aware of certain features in vehicles may be made aware of these features through a vehicle setting recommendation. Additionally, in some implementations, drivers may not have to provide particular data about the driver's interests or profile. The system disclosed herein utilizes neural networks that can learn about the driver's preferences or preferred vehicle settings and generate vehicle recommendations accordingly. An additional advantage includes a driver being informed of new features or settings as the features or settings are updated from vehicle manufacturers. Consequently, drivers may be able to enjoy their vehicles more as they are informed of features and capabilities of their vehicles that they may not have been aware of.

Other implementations of these aspects include corresponding systems, apparatus, computer-readable storage mediums, and computer programs configured to implement the actions of the above-noted methods.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts a portable vehicle settings data sharing system.

FIG. 2 depicts an exemplary implementation of a network server.

FIG. 3 depicts exemplary operations executed by a network server to provide vehicle setting recommendations.

FIG. 4 depicts a flowchart of exemplary operations executed by a vehicle and other system devices in response to receiving a request for vehicle setting recommendations.

FIGS. 5A and 5B depict an exemplary scenario in which vehicle setting values are modified to accommodate an approaching driver.

FIGS. 6A and 6B depict exemplary implementations of vehicle setting recommendations received by a vehicle control module.

Like reference numbers and designation in the various drawings indicate like elements.

### DETAILED DESCRIPTION

This disclosure generally describes methods and systems for obtaining crowd-sourced vehicle setting data and using machine learning to recommend vehicle setting values for a driver.

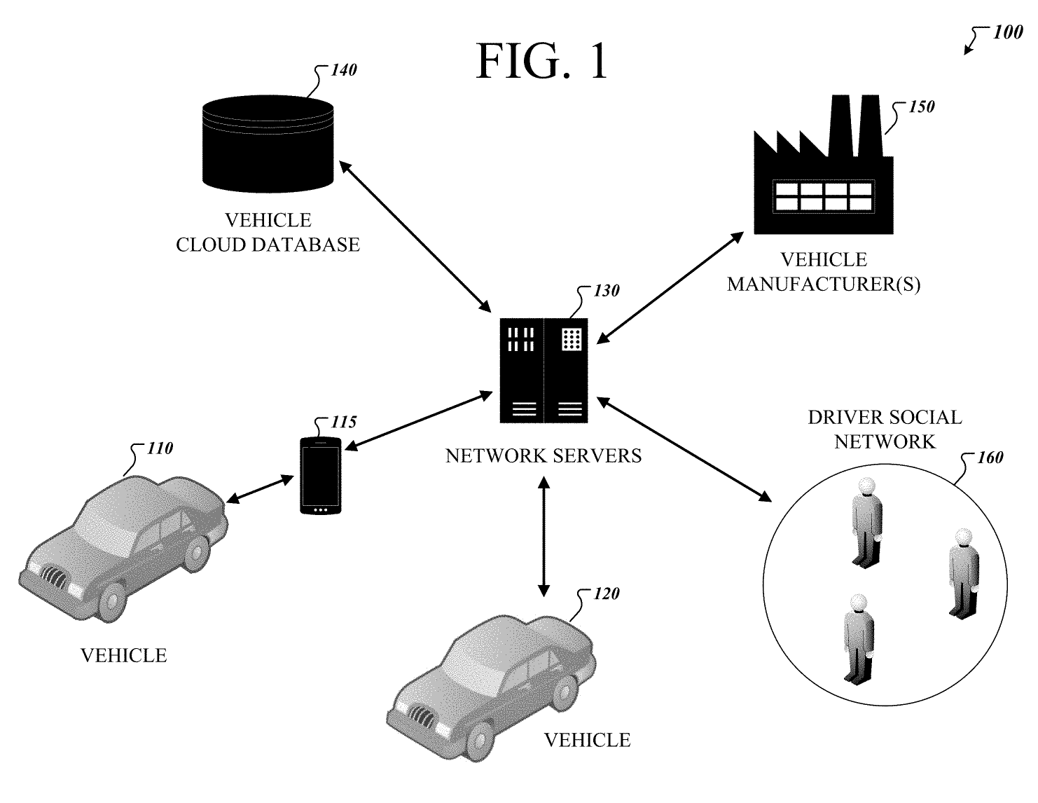

FIG. 1 depicts a vehicle settings data sharing system 100 that includes vehicle 110, user device 115, vehicle 120, one or more network servers 130, a vehicle cloud database 140, one or more vehicle manufacturers 150, and a driver social network 160. Although two vehicles 110, 120 are shown in system 100, any suitable number of vehicles may be present in the system 100 at any time.

System 100 may include one or more networks that are configured to provide network access, data transport, and other services to any interface connected to the one or more networks. In general, the one or more networks may include and implement commonly-defined network architectures including those defined by standards bodies, such as the Global System for Mobile communication (GSM) Association, the Internet Engineering Task Force (IETF), and the Worldwide Interoperability for Microwave Access (WiMAX) forum. For example, the one or more networks may implement one or more of a GSM architecture, a General Packet Radio Service (GPRS) architecture, a Universal Mobile Telecommunications System (UMTS) architecture, and an evolution of UMTS referred to as Long Term Evolution (LTE). The one or more networks may implement a WiMAX architecture defined by the WiMAX forum or a Wireless Fidelity (WiFi) architecture. The one or more networks may include, for instance, a local area network (LAN), a wide area network (WAN), the Internet, a virtual LAN (VLAN), an enterprise LAN, a layer 3 virtual private network (VPN), an enterprise IP network, or any combination thereof.

The one or more networks may include access points, storage systems, cloud systems, modules, one or more databases including vehicle cloud database 140, and servers including one or more network servers 130. The one or more network servers 130 may include any suitable computing device coupled to the one or more networks, including but not limited to a personal computer, a server computer, a series of server computers, a mini computer, and a mainframe computer, or combinations thereof. The one or more network servers 130 may also include a web server, or a series of servers, running a network operating system, examples of which may include but are not limited to Microsoft® Windows® Server, Novell® NetWare®, or Linux®. The one or more network servers 130 may be used for and/or provide cloud and/or network computing. Although not shown in the figures, the server may have connections to external systems providing messaging functionality such as e-mail, SMS messaging, text messaging, and other functionalities, such as advertising services, search services, etc.

In some implementations, the one or more networks may include a cloud system that may provide Internet connectivity and other network-related functions. For example, the cloud system may provide storage services for at least a portion of the data transmitted between components of system 100.

System 100 also includes a vehicle cloud database 140, which may include a cloud database or a database managed by a database management system (DBMS). A DBMS may be implemented as an engine that controls organization, storage, management, and retrieval of data in a database. DBMSs frequently provide the ability to query, backup and replicate data, enforce rules, provide security, do computation, perform change and access logging, and automate optimization. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

In some implementations, the vehicle cloud database 140 may store vehicle setting data that may be specific to a particular driver, specific to a particular vehicle make and model, or may be abstracted vehicle setting values associated with a profile of a driver. The vehicle cloud database 140 may categorize the stored vehicle setting data by driver profile or by vehicle make and model.

Vehicle settings may include mirror positions, seat position, steering wheel position, foot pedal positions, radio station presets, heating, ventilation, air conditioning (HVAC) settings, lighting preferences, e.g., timings for turning fog lights on or off, internal light settings, wiper speed settings, navigation settings, bumper camera settings, safety alert settings, e.g., low fuel alerts, blind spot alerts, child lock settings, and window lock settings. In general, the vehicle settings may include any driver or passenger-configurable option or setting in a vehicle.

Vehicle settings specific to a vehicle may have a range of values and corresponding limits for a particular vehicle setting. For example, the vehicle cloud database 140 may store a first range of positions that a driver seat position can be adjusted in one vehicle and a second range of positions that a driver seat position can be adjusted in another vehicle. Accordingly, the vehicle cloud database 140 may maintain a record of different vehicles, and for each vehicle, the vehicle options, specifications, and the range of particular settings within the vehicle.

It should also be appreciated that different vehicles may have different settings and operation modes. For example, one vehicle may be configured to operate in a sports mode and may have vehicle setting values applicable or selected for the sports mode. Another vehicle may be configured to operate in a highway mode and may have vehicle setting values applicable or selected for the highway mode. As another example, an electric vehicle may have one or more vehicle settings for optimizing vehicle battery life and usage. Another diesel or gasoline-based vehicle may have one or more vehicle settings for optimizing fuel consumption.

In some implementations, the vehicle cloud database 140 may communicate with one or more vehicle manufacturers 150 to receive updates and information regarding vehicle settings of new vehicle models or changes in vehicle setting parameters of existing vehicle models.

In some implementations, the vehicle cloud database 140 may store driver identification data that includes, for example, one or more of a user name or identification, password, driver's license data, or biometric data of the driver.

In some implementations, the vehicle cloud database 140 may maintain one or more driver profiles. The driver profiles may include a likely physical profile of the driver, which includes data indicating various relevant physical characteristics of the driver such as, for example, a likely height, arm length, and leg length. The various physical characteristics of the driver can be estimated based on average vehicular setting values used by a driver or, in some cases, vehicular settings for a car most frequently driven by the driver. For example, if a driver generally sets the driver car seat position at a position close to the steering wheel in multiple cars or in a car the driver most frequently drives, the likely height of the driver may be determined to be, for example, less than 5′6″. In another example, if a driver generally sets the driver car seat position at a maximum distance away from the steering wheel in multiple cars, the likely height of the driver may be determined to be, for example, at least 6′.

Various different and suitable methodologies may be used to determine the likely physical characteristics of a driver. For example, in some implementations, a reference table may be used to determine a corresponding driver height from a seat position or distance from the steering wheel of a particular vehicle. In some implementations, a driver may be requested through the vehicle navigation system or the driver's portable electronic device to provide information on the driver's physical characteristics. In some implementations, an alignment or orientation of mirrors may be used to determine the likely location of a driver's head and a likely height of the driver.

In addition to the likely physical characteristics of a driver, the driver profile may also include data indicative of the personal preferences. For example, data indicating the ambient temperature within a car, radio station presets, lighting settings, safety alert settings, child lock settings, or window lock settings preferred by the driver may be stored in the driver profile.

Further to the descriptions above, a driver may be provided with controls allowing the driver to elect if or when systems, programs or features described herein may collect driver information (e.g., physical characteristics, information about a driver's social network, social actions or activities, profession, a driver's preferences, or a driver's current location), and if the driver is interested in receiving content or communications from a server.

In addition, certain data may be treated in one or more ways before it is stored or used, so that personally identifiable information is removed. For example, a driver's identity may be treated so that no personally identifiable information can be determined for the driver, or a driver's geographic location may be generalized where location information is obtained (such as to a city, ZIP code, or state level), so that a particular location of a driver cannot be determined. Thus, the driver may have control over what information is collected about the driver, how that information is used, and what information is provided to the driver.

Each of vehicle 110 and vehicle 120 may be one of an automobile, rickshaw, moped, motor cycle, bicycle, snowmobile, truck, Segway, etc. Vehicle 110 and vehicle 120 may each correspond to one of various suitable makes and models including, for example, a Honda Civic, Honda Accord, Toyota Camry, Volkswagen Beetle, Mercedes Benz CLK, BMW 5 series, Chevrolet Corvette, etc. In some implementations, vehicle 110 and vehicle 120 may each include a vehicle control module to control one or more operations of vehicle 110 and vehicle 120, respectively.

As described in further detail below, the vehicle control module is configured to communicate directly or indirectly through system 100 to communicate with other system 100 elements such as the one or more network servers 130, user device 115, vehicle cloud database 140, other vehicles, one or more vehicle manufacturers 150, and the driver social network 160. For example, the vehicle control module may communicate with user device 115 to obtain information about a driver carrying the user device 115 or to send and receive information about the vehicle or vehicle setting data.

In some implementations, the vehicle control module may also be connected to various components and sensors of the vehicle to implement commands and operations or to determine a status of the components and sensors in the vehicle. Accordingly, the vehicle control module may provide status information about a component or sensor in the vehicle to system 100 elements such as the one or more network servers 130 or the user device 115. For example, the vehicle control module can provide a notification if a door is not locked or information indicating the ambient temperature in the vehicle based on data received from components and sensors in the vehicle. The vehicle control module may also transmit signals to control or configure the components and sensors in the vehicle.

The user device 115 may be any suitable portable electronic device. Examples of a portable electronic device include, but are not limited to, a computer, lap top, personal digital assistant, electronic pad, electronic notebook, telephone, smart phone, television, smart television, a watch, smart glasses, or any electronic device that is connected to a network and has a display. The user device 115 may be any combination of hardware and software and may execute any suitable operating system such as an Android® operating system.

The user device 115 may be used by a driver of vehicle 110. The user device 115 may include an application that allows the user device 115 to communicate with vehicle 110 and one or more network servers 130. For example, in some cases, an application on the user device 115 may control the user device 115 to communicate with a vehicle control module in vehicle 110. The driver of the vehicle 110 may be a renter, owner, or passenger of vehicle 110.

The driver or user of vehicle 110 may elect to download a portable vehicle settings application onto user device 115. The portable vehicle settings application is configured to display a graphical user interface on the user device 115 to receive information from or present information to the driver. The portable vehicle settings application may also be configured to communicate with vehicle control modules of a plurality of vehicles.

After downloading the portable vehicle settings application, in some implementations, the driver may provide information regarding one or more vehicles that the driver most frequently uses. This information may include one or more of a make and model of the vehicle, a vehicle identification number, a registration of the vehicle, and preferred vehicle setting values of the driver in the one or more vehicles, respectively. The information regarding one or more vehicles may be stored in the user device 115 or a driver profile in the vehicle cloud database 140. In some implementations, the driver may not provide any information regarding a vehicle after downloading the portable vehicle settings application, but the user device 115 may communicate with one or more vehicle control modules in the one or more vehicles, respectively, to obtain information regarding the one or more vehicles, respectively.

In some cases, the application on the user device 115 may forward vehicle setting recommendations received from any one of the vehicle cloud database 140, network servers 130, or one or more vehicle manufacturers 150. In some cases, the user device 115 may obtain driver vehicle setting values used by a driver who is in possession of the user device 115 and is driving or has driven vehicle 110. The obtained driver vehicle setting values or data may be transmitted to network servers 130 and subsequently stored in vehicle cloud database 140. In some cases, the user device 115 may transmit driver vehicle setting data, including vehicle setting recommendations, to a vehicle upon detecting that the vehicle is within a threshold distance of the driver who is possession of the user device 115. The threshold distance may be set by an application developer, user device or vehicle manufacturer, or the driver to any suitable distance, for example, 1 meter (m), 3 m.

The one or more network servers 130 may also be configured to communicate with one or more vehicle manufacturers 150 and one or more social networks 160 associated with the driver. The one or more vehicle manufacturers 150 may include any vehicle manufacturer such as Toyota, Honda, Mercedes-Benz, etc. The social networks 160 may include various types of social network such as Facebook, Twitter, Instagram, and may also include social network websites and blogs. The social networks 160 may include friends, family, or followers of a driver. The one or more vehicle manufacturers 150 may transmit updates and information regarding vehicle settings of new vehicle models or changes in vehicle setting parameters of existing vehicle models to the one or more network servers 130.

As shown in FIG. 1, network servers 130 may communicate directly with a vehicle 120 or may communicate with a vehicle 110 through a user device 115. In some implementations, the communication between network servers 130 and vehicles 110 and 120 may include abstracted vehicle setting data received from vehicles 110 and 120. The abstracted vehicle setting data includes metadata identifying a make and model of the vehicle (e.g., vehicles 110 and 120) the abstracted vehicle setting data is received from, and values of vehicle settings being used in vehicles 110 and 120. The abstracted driver vehicle setting data may include data indicative of various vehicle setting values such as one or more of mirror positions, a driver seat position, steering wheel position, foot pedal positions, radio station presets, heating, ventilation, air conditioning (HVAC) settings, vehicle lighting preferences, wiper speed settings, navigation settings, camera bumper settings, safety alert settings, child lock settings, and window lock settings.

In some implementations, if the drivers of vehicles 110 and 120 give consent to sharing driver profile information, anonymized driver profile information such as a likely height, a likely arm length, and a likely leg length of the drivers may also be communicated to network servers 130 along with the abstracted vehicle setting data. The anonymized driver profile information does not include any identification information of the driver.

The network servers 130 may store the abstracted vehicle setting data in vehicle cloud database 140 in various suitable manners. For example, in some cases, the abstracted vehicle setting data may be categorized according to the type of vehicle make and model. In some cases, the abstracted vehicle setting data may be categorized according to a type of driver profile.

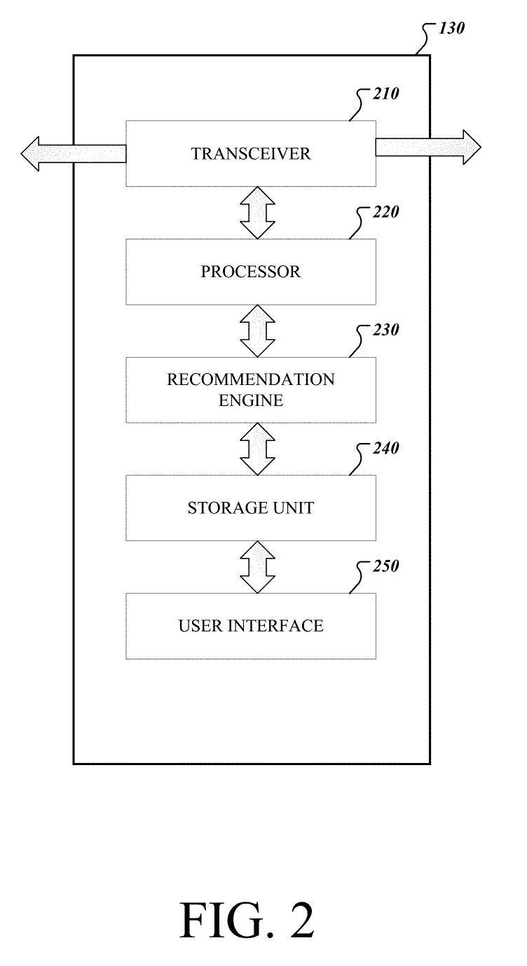

FIG. 2 illustrates an exemplary implementation of one of the one or more network servers 130. As shown in FIG. 2, each network server 130 may include a transceiver 210, a processor 220, a recommendation engine 230, a storage unit 240, and a user interface 250. The recommendation engine 230 may include one or more neural networks.

A transceiver 210 includes a transmitter and a receiver and may be utilized to communicate with other devices in system 100. The transceiver 210 may include amplifiers, modulators, demodulators, antennas, and various other components. The transceiver 210 may communicate with vehicles 120, 130, vehicle cloud database 140, vehicle manufacturers 150, and driver social networks 160. The transceiver 210 may direct data received from other devices in system 100 to other components of the network server 130 such as the processor 230 and storage unit 240. The transceiver 210 may also direct data received from components of the network server 130 to other devices in system 100.

The user interface 250 may include a display unit, input unit, and one or more sensors. The sensors may include an optical sensor, capacitive sensor, charge-coupled device sensor, gyroscope, microphone, altimeter, impact sensor, piezoelectric sensor, motion sensor, biosensor, active pixel sensor, and various other sensors that may detect one or more conditions or receive inputs. The input unit may include various devices that are configured to receive one or more inputs. For example, the input unit may include a mouse, touch pad, or keyboard for receiving alphanumeric text.

The display unit in the user interface 250 may display various data. The display unit may be implemented through suitable displays including, for example, a projection display, a liquid crystal display (LCD), or light emitting diode (LED) display. In some implementations, the display unit, input unit, and one or more sensors may be combined into a single integrated component, and, in some implementations, the display unit, input unit, and one or more sensors may be multiple components.

The processor 230 may be coupled to all components of the network server 130, and may control the operations of the network server 130. The processor 230 may include various logic circuitry and programs to execute the various implementations described herein.

Storage unit 240 may include one or more mass storage devices, e.g., magnetic, magneto optical disks, optical disks, EPROM, EEPROM, flash memory devices, and may be implemented as internal hard disks, removable disks, magneto optical disks, CD ROM, or DVD-ROM disks for storing data. The storage unit 240 may store rules for training neural networks.

Recommendation engine 230 generates vehicle setting recommendations based on the abstracted vehicle setting data received from multiple vehicles. In some implementations, the recommendation engine 230 includes one or more neural networks. Rules and protocols stored in the storage unit 240 may be used to configure and train the one or more neural networks, which may include one or more classifiers. For example, the one or more classifiers may be trained to detect patterns of frequently-used vehicle settings, driver preferences, and unused or intermittently-used vehicle settings for a particular vehicle make or model in the abstracted vehicle setting data received from multiple vehicles. The one or more classifiers are also trained based on any feedback or corrective information provided by administrators or drivers.

The recommendation engine 230 may generate vehicle setting recommendations according to a vehicle make and model or according to driver profiles. For example, if the system 100 receives abstracted vehicle setting data indicating that most drivers of a particular vehicle make and model prefer to drive the vehicle with a particular internal light emitting diode (LED) lights setting, the one or more neural network classifiers may be configured to generate recommendations for drivers of the particular vehicle make and model that do not have the internal LED lights setting activated to adjust the settings of their vehicles so that these drivers can also experience the internal LED lighting setting.

In another example, the network server 130 may receive abstracted vehicle setting data indicating that most drivers with a height greater than 5′10″ that drive a particular vehicle make and model have the brake pedal set at a particular height. The one or more neural network classifiers may then generate recommendations for other drivers that (i) have a height greater than 5′10″, (ii) drive the particular vehicle make and model, and (iii) have a different brake pedal setting, to consider adjusting the brake pedal to the particular height enjoyed by most other drivers that have a height greater than 5′10″ and drive the particular vehicle make and model.

The one or more neural networks may be trained to use one or more criteria to generate the vehicle setting recommendation. The one or more criteria include a frequency of use of a particular vehicle setting, a social network trending popularity of the particular vehicle setting, a safety rating of the particular vehicle setting, and a recommendation from a manufacturer of a particular vehicle make and model. In some implementations, if a profile of the driver is available, the one or more criteria may also include driver preferences, driver interests, and a likely physical profile of the driver.

Each of the one or more criteria may be allocated a weight. The weights for the criteria may vary based on the type of recommendation. For example, if a vehicle setting recommendation is being generated based on driver profiles, the criteria of driver preferences and interests may be given a greater weight relative to, for example, the criterion of frequency of use of a particular vehicle setting. However, if the vehicle setting recommendation is being generated based on a vehicle make and model, the criterion of frequency of use of a particular vehicle setting may be allocated a greater weight relative to the weight allocated to the criterion of frequency of use when the vehicle setting recommendation is generated based on driver profiles.

The neural networks determine a score for a particular vehicle setting based on the criteria and respective assigned weighed. In some implementations, the score, S, may be determined by the following equation:

Sᵥₛ=c₁w₁+c₂w₂. . . cₙwₙ.

c represents a criterion; w represents a weight; and n is any number greater than one and corresponds to the number of criteria used to score a particular vehicle setting.

In general, various suitable methods to generate a score for a particular vehicle setting based on the criteria and respective assigned weighed may be used.

The neural networks may generate an order of vehicle settings to recommend based on the scores for the respective vehicle settings. Vehicle settings having a higher score may be ranked higher and prioritized for including in a vehicle setting recommendation. For example, if the vehicle setting for pedal positions is determined to have a lower score than a score for the vehicle setting for internal vehicular lighting, a vehicle setting recommendation for internal vehicular lighting will be generated before a vehicle setting recommendation for pedal positions is generated.

In general, for a vehicle setting to be recommended, the score for the vehicle setting must satisfy a threshold. If the score for the vehicle setting does not satisfy the threshold, a recommendation for the vehicle setting is not generated. If the score for the vehicle setting does satisfy the threshold, a recommendation for the vehicle setting is generated. The threshold may be set by a network administrator or system designer.

As noted above, driver profiles may be stored in vehicle cloud database 140 and may include a likely physical profile of the driver and, in some cases, preferences of the driver. In some implementations, the recommendation engine 230 may obtain information from the driver profile to generate vehicle setting recommendations. If the likely profile of a driver of a vehicle for which a vehicle setting recommendation is to be generated matches one of the driver profiles stored in the vehicle cloud database 140, the recommendation engine 230 may utilize one or more recommendations associated with the matched driver profile in the vehicle cloud database 140 to recommend to the driver of the vehicle. Matching the likely profile of the driver of the vehicle to driver profiles stored in the vehicle cloud database 140 may include matching one or more of a likely height, a likely arm length, and a likely leg length of the driver of the vehicle with one or more of a likely height, a likely arm length, and a likely leg length in a driver profile stored in the vehicle cloud database 140.

After the recommendation engine 230 generates a vehicle setting recommendation, the network server 130 may send the vehicle setting recommendation directly to a vehicle, e.g., vehicle 110 or 120, or to user device 115 of a driver of the vehicle using any suitable messaging mechanism.

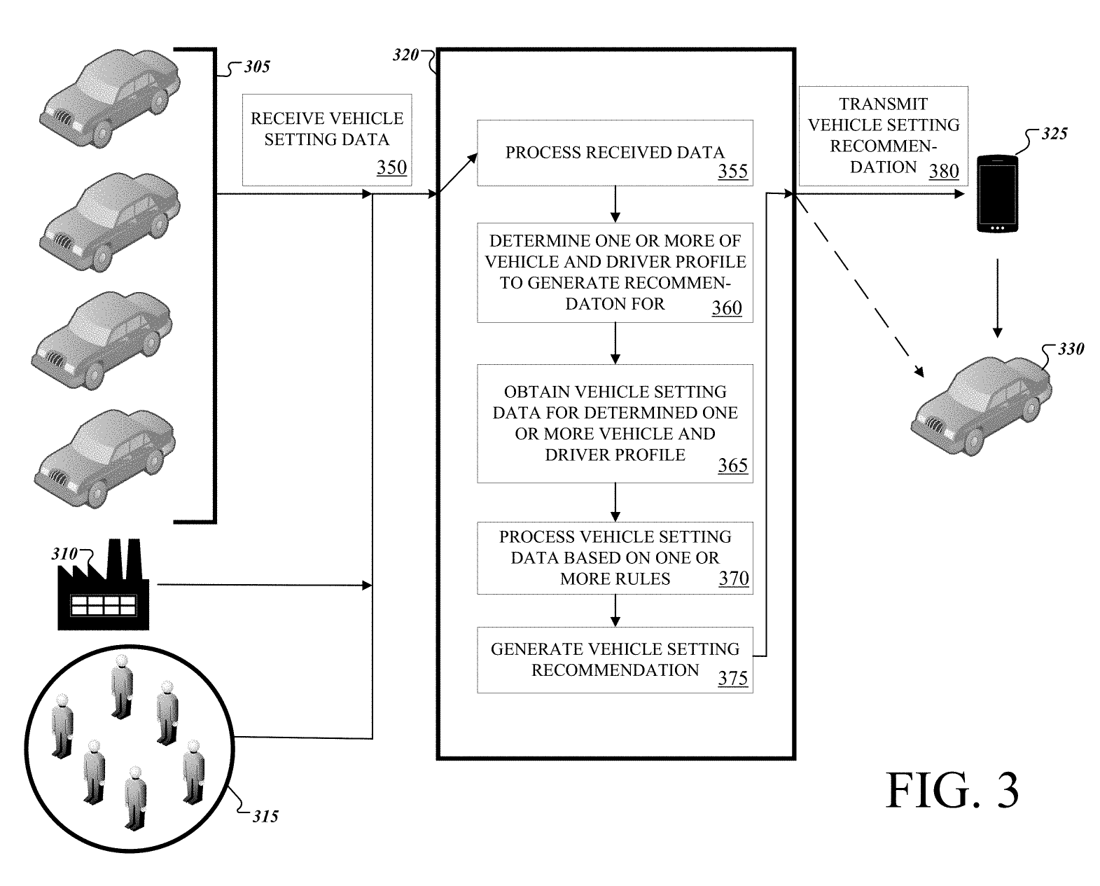

FIG. 3 depicts exemplary operations executed by a network server to provide vehicle setting recommendations. The operations may be executed by one or more network servers 320 (referred to as “network server 320” for the discussion of FIG. 3), which may communicate directly or indirectly with a plurality of vehicles 305 and 330, vehicle manufacturers 310, social network servers 315, and user device 325.

The network server 320 may receive vehicle setting data from a plurality of vehicles 305, from vehicle manufacturers 310, and from social network servers 315 (operation 350). The vehicles 305 may be of any make or model capable of communicating over a wireless interface with the network server 320 or with a portable electronic device that communicates with the network server 320. The vehicle setting data provided by vehicles 305 to network server 320 may include one or more of vehicle settings currently applied by a driver of the vehicle, a change in a vehicle setting applied by a driver, a make, model, and various other manufacturing details of the vehicle, or driver-related information if and as authorized by the driver. The vehicles 305 may also provide information about problems or defects frequently occurring as a result of applying one or more vehicle settings in the vehicles 305.

The vehicle manufacturers 310 may provide information about any new vehicles released into the vehicle market by the vehicle manufacturers 310 such as make and model information for new vehicles and optimal settings associated with the new vehicles for one or more driver profiles. The vehicle manufacturers 310 may also provide information to the network server 310 about updates to any vehicle settings, reports of any vehicle recalls or defects due to one or more settings in vehicles manufactured by the vehicle manufacturers 310. Reference to vehicle manufacturers 310 in this disclosure includes servers being operated, leased, utilized, or controlled by the vehicle manufacturers 310.

The social network servers 310 may include servers associated with various social networks, including but not limited to, Facebook, Twitter, Instagram, Pinterest, and may also include social network websites and blogs. The social network servers 310 may provide information about vehicle settings circulating on the various social media platforms. For example, the social network servers 310 may provide information about a popular vehicle setting utilized by a race car driver, vehicle performance optimization tricks of the trade by automobile specialists, or trending topics in the news such as vehicle recalls due to particular vehicle settings. In general, the social network servers 310 may provide any information regarding vehicle settings to the network server 320.

After receiving the vehicle setting data from various sources, the network server 320 processes the received data (operation 355). For example, the network server 320 may identify a particular vehicle make and model for which vehicle setting data is received. In some cases, if driver information is also received, the network sever 320 may identify a driver profile associated with the received vehicle setting data.

After identifying the vehicle or driver profile, the network server 320 will search the vehicle cloud database, as described above, for a matching vehicle or driver profile, and update records in the vehicle cloud database with the received vehicle setting data. For instance, if vehicle setting data is received for a 2016 BMW M3, the network server 320 may update information for 2016 BMW M3s in the vehicle cloud database with the received vehicle setting data. The received vehicle setting data may be, for example, the internal LED lighting settings used in hundreds of 2016 BMW M3 vehicles. The network server 320 may update the vehicle cloud database to reflect the received internal LED lighting settings and increase a count associated with this setting to indicate the number of vehicles using this setting. If the count crosses a particular threshold, the setting may be labeled as a setting that is frequently used in the 2016 BMW M3.

In another example, if information associated with a particular driver profile is received from the vehicles 305, the network server 320 may search the vehicle cloud database for information regarding the particular driver profile and update the vehicle cloud database for the particular driver profile with the received vehicle setting data. For example, if the network server 320 receives information about a seat position of a 6′4″ driver of a 2016 Honda Civic EX, the network server 320 may update databases for one or more of the 2016 Honda Civic EX and 6′4″ drivers of a 2016 Honda Civic EX in the vehicle cloud database with details of the seat position.

The network server 320 may update the vehicle cloud database on a continuous basis as information is received from various sources, as noted above. If a database for an identified vehicle or driver profile is not located by the network server 320, the network server 320 may create a new database in the vehicle cloud database for the identified vehicle or driver profile and update the created database as more vehicle setting data are received.

Next, the network server 320 may determine whether a vehicle setting recommendation should be generated (operation 360). The network server 320 may use one or more rules and criteria to determine whether to generate a vehicle setting recommendation. In some cases, the network server 320 may determine that a particular vehicle setting recommendation should be generated in response to receiving a request for the particular vehicle setting recommendation. For instance, the network server 320 may receive a request for a vehicle setting recommendation for a newly released car. In some cases, the network server 320 may generate vehicle setting recommendations according to a particular schedule. In these cases, when the time specified by the particular schedule is reached, the network server 320 may generate the vehicle setting recommendations for the particular schedule. In some cases, the network server 320 may generate vehicle setting recommendations for a new vehicle when the new vehicle is released in the market. In some cases, the network server 320 may generate vehicle setting recommendations for vehicles for which a recall has been issued.

After determining that a vehicle setting recommendation should be generated, the network server 320 may obtain vehicle setting data for the vehicle or driver profile for which the vehicle setting recommendation is to be generated (operation 365). To obtain the vehicle setting data, the network server 320 may search one or more information sources such as the vehicle cloud database for vehicle setting data associated with the vehicle or driver profile.

After obtaining vehicle setting data, the network server 320 may process the obtained vehicle setting data using neural networks and one or more rules. For example, if a recommendation associated with mirror positions is being generated for a particular vehicle, but most previous recommendations associated with mirror positions for the particular vehicle have been dismissed by the driver of the particular vehicle, the network server 320 may terminate the process for generating a vehicle setting recommendation.

In some cases, if the neural network has detected that a setting in a vehicle of a particular make and model is rarely utilized, the neural network may determine this lack of use as either a lack of awareness of the setting or a rejection of this setting. If the vehicle cloud database does not have data indicating that the setting has been rejected in many vehicles, e.g., by relying on a low rejection count or percentage of vehicles rejecting this setting, the neural network may determine that drivers of vehicles with the particular make and model may generally be unaware of the vehicle setting. The neural network may then instruct the network server 320 to generate a recommendation for the vehicle setting that drivers may generally be unaware of.

As noted above, the one or more criteria may include a frequency of use of a particular vehicle setting, a social network trending popularity of the particular vehicle setting, a safety rating of the particular vehicle setting, and a recommendation from a manufacturer of a particular vehicle make and model. In some implementations, if a profile of the driver is available, the one or more criteria may also include driver preferences, driver interests, and a likely physical profile of the driver. As described above, a score maybe calculated using the criteria and respective weights.

In general, various rules and criteria may be used to process the obtained vehicle setting data and determine whether or not to generate vehicle setting recommendations. In addition, the neural networks may be trained and updated on a continuous or periodic base so that the criteria and rules for generating vehicle setting recommendations remain up-to-date and provide recommendations that are relevant and useful for drivers.

After processing the obtained vehicle setting data and determining that a vehicle setting recommendation should be generated, the network server 320 generates the vehicle setting recommendation with the obtained vehicle setting data or a portion of the obtained vehicle setting data that satisfied the rules and criteria in operation 370 (operation 375).

Various methods may be used to generate the vehicle setting recommendations. In some implementations, the method of generation may depend on the device receiving the vehicle setting recommendation. For example, if the vehicle setting recommendation is being transmitted to a portable electronic device that is not a vehicle control module of a vehicle, the vehicle setting recommendation may be generated using formats, such as a short messaging service (SMS) text, a multimedia messaging service (MMS) message, or a video. If the vehicle setting recommendation is being transmitted to a vehicle, the vehicle setting recommendation may be generated using alphanumeric text. Operations 365-375 may be performed by the recommendation engine 230 in a network server as described above.

While generating the vehicle setting recommendation, the network server 120 may also obtain destination information such as an IP address, MAC address, or other network addresses of the one or more devices associated with the driver profile or vehicle make and model for which the vehicle setting recommendation has been generated. This information may be obtained from the vehicle cloud database, which may also include a registry of devices from which information has been received, devices from which a request for vehicle setting recommendations has been received, or devices to which information may be transmitted.

The network server 320 may then transmit the generated vehicle setting recommendation to, in some cases, a user device 325 associated with a driver of vehicle 330, or, in some cases, directly to a vehicle control module in vehicle 330 (operation 380).

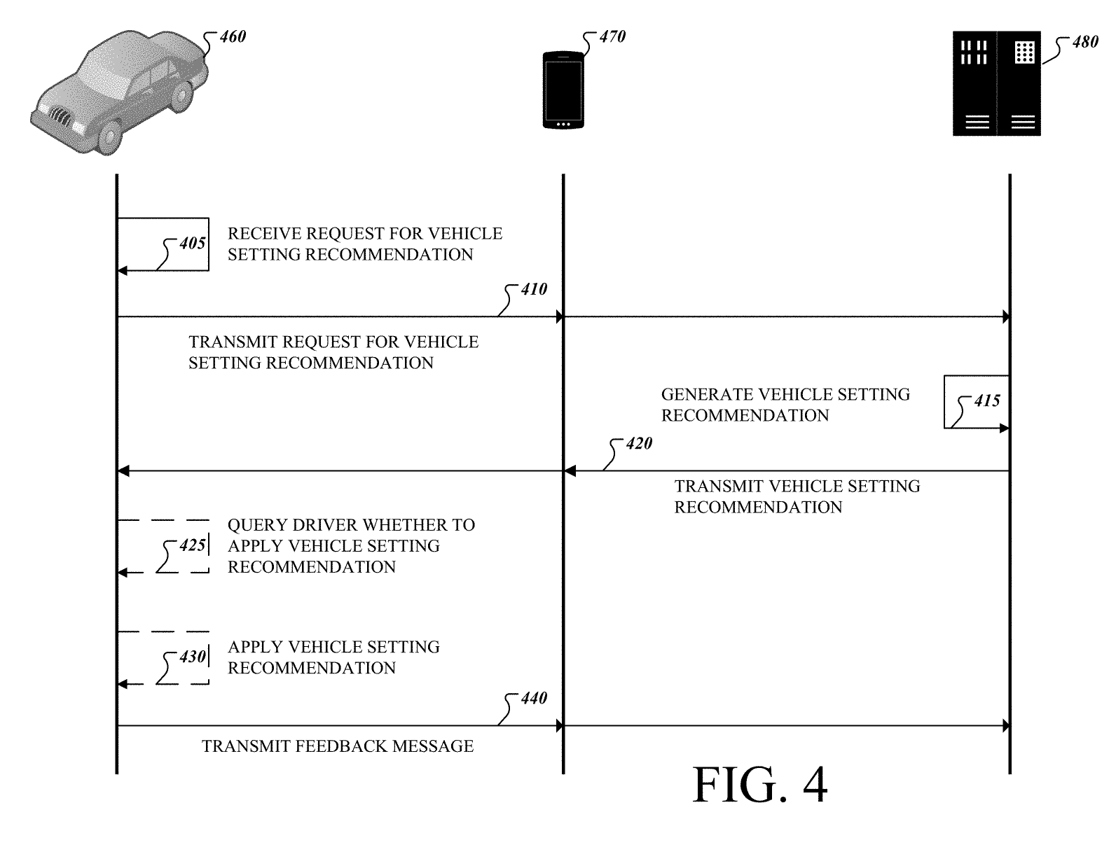

FIG. 4 depicts a flowchart of operations executed by a vehicle and other system devices in response to receiving a request for vehicle setting recommendations. FIG. 4 depicts interactions between a vehicle 460, a user device 470 associated with the vehicle 460, and a network server 480. The user device 470 associated with the vehicle 460 may refer to any portable electronic device that is owned, rented, or possessed by a driver of the vehicle 460. The driver of the vehicle 460 may be a renter, owner, or passenger of vehicle 460.

Referring to FIG. 0.4, a vehicle control module in vehicle 460 may receive a request for a vehicle setting recommendation (operation 405). This request may be received from the driver of the vehicle 460 or may be generated automatically by vehicle 460 according to a predetermined schedule for receiving updates and recommendations for vehicle settings. The predetermined schedule may be set by a vehicle manufacturer or the driver. The driver may request the vehicle setting recommendation through a user interface such as a display or navigation panel in vehicle 460 or may transmit the request to the vehicle control module using user device 470.

The vehicle control module may then generate a request for a vehicle setting recommendation and transmit the request directly to the network server 480 or, in some case, indirectly to the network server 480 via user device 470 (operation 410).

In some implementations, the user device 470 may detect that the driver is within a threshold distance of a vehicle and send a request for vehicle setting recommendations to the network server 480. The request from the user device 470 may be transmitted to the network server 480 directly or through the vehicle control module in vehicle 460.

When the network server 480 receives the vehicle setting recommendations, the network server 480 may execution operations 355-375, as described with reference to FIG. 3 (operation 415). The network server 480 may then directly transmit the generated vehicle setting recommendation to the vehicle control module of vehicle 460 or indirectly via user device 470 (operation 420). When the portable electronic device receives the vehicle setting recommendation, the portable electronic device may transmit the vehicle setting recommendations to vehicle 460 upon detecting that the vehicle 460 is within a threshold distance of the driver.

When vehicle 460 receives the recommendation, the vehicle control module in vehicle 460 may determine the status of the vehicle 460. If the vehicle 460 is determined to be moving, the vehicle control module may wait until the vehicle 460 is in the parking gear or is in a stationary position. When the vehicle 460 is not moving, the vehicle control module may output the received vehicle setting recommendation through the vehicle's speakers or through a display in the vehicle 460. The vehicle control module may then query the driver of the vehicle 460 as to whether the driver would like to accept and apply the vehicle setting recommendation (operation 425).

In response to the query, the driver may elect to dismiss the recommendation, accept the recommendation, or ask for more information. If the driver dismisses the recommendation, a feedback message may be transmitted to the network server 480 indicating that the recommendation has been dismissed (operation 440). If the driver accepts the recommendation, the vehicle control module may apply the vehicle setting recommendation (operation 430), and transmit a message to the network server 480 indicating that the recommendation has been accepted (operation 440).

If the driver asks for more information, the vehicle control module may submit a query for additional information regarding the recommended vehicle setting to one or more information sources such as the Internet or may query the network server 480 for more information.

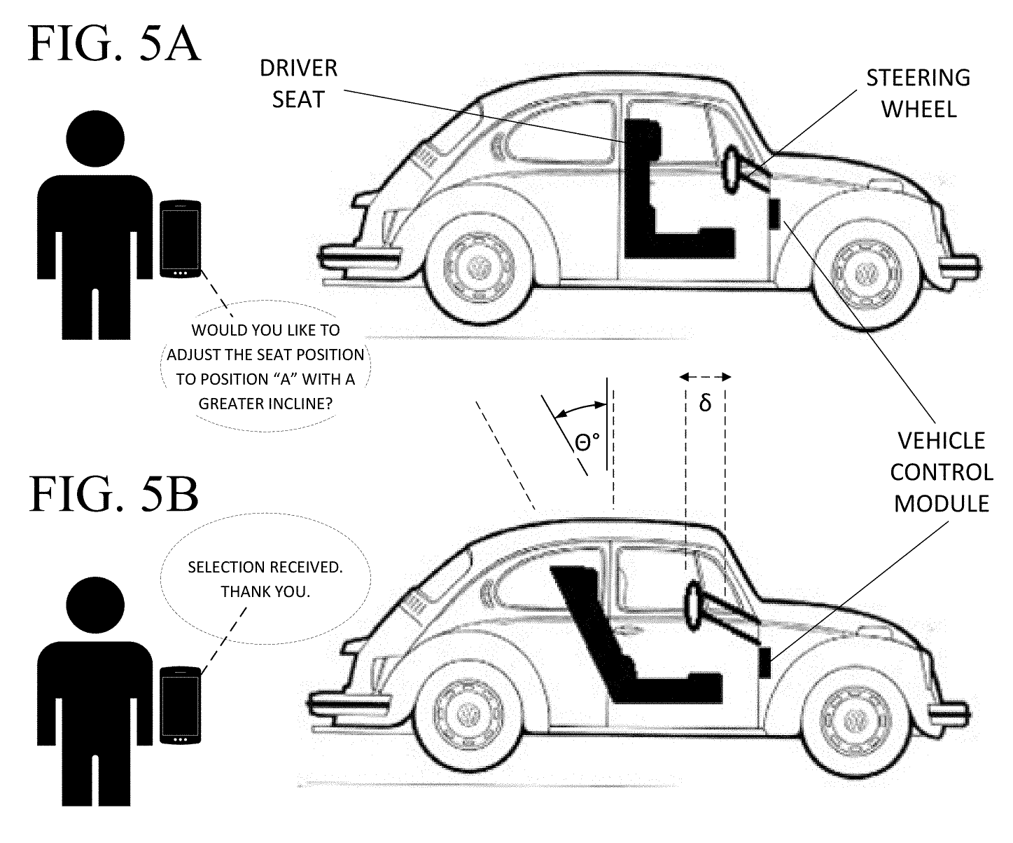

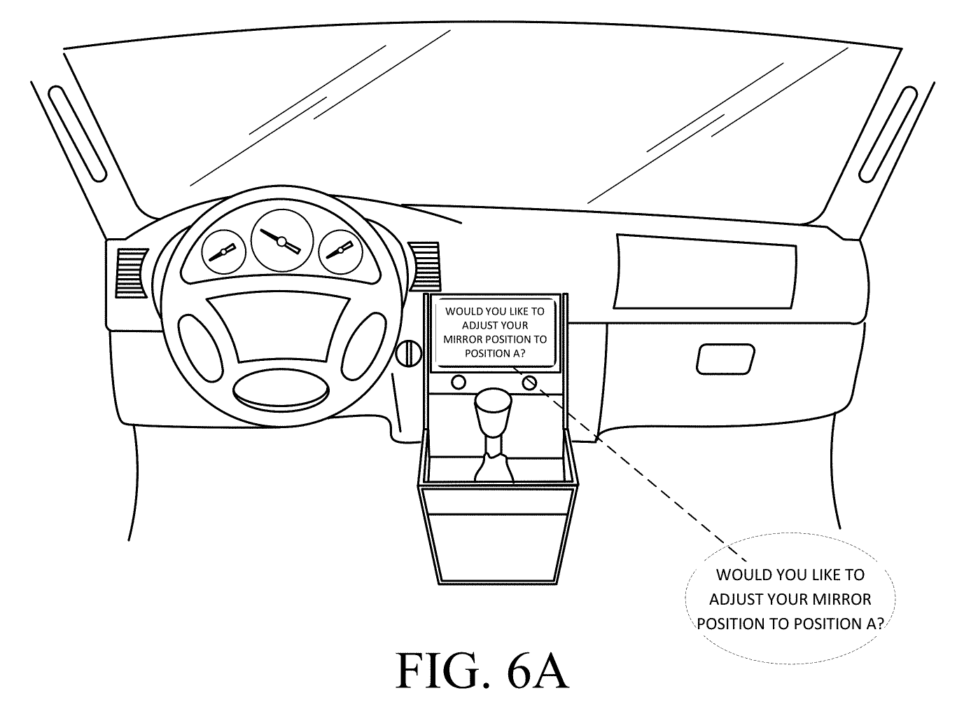

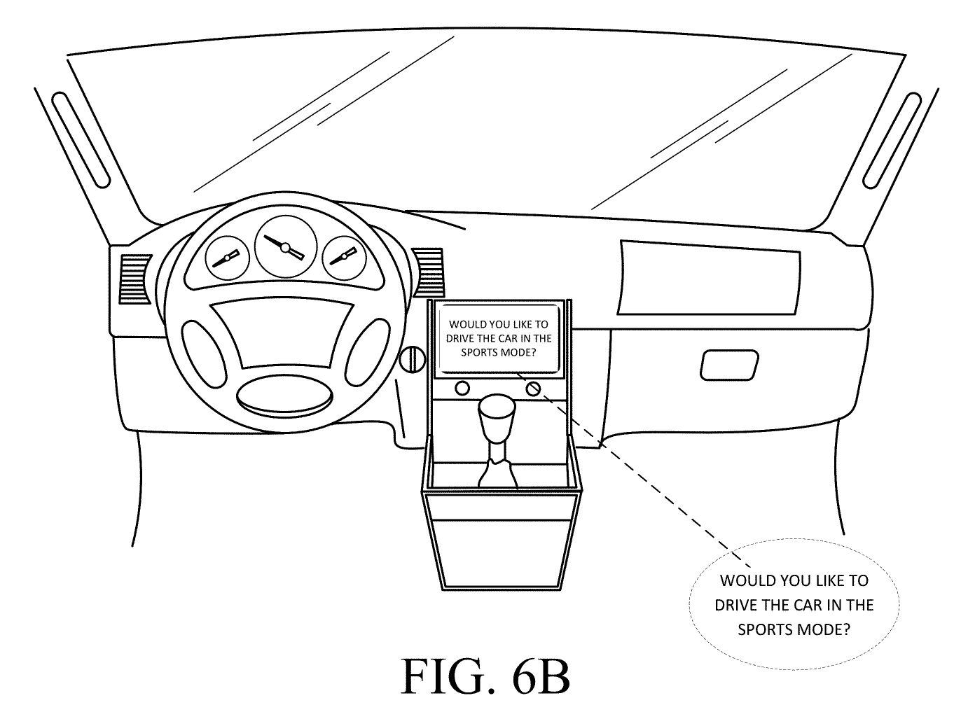

FIGS. 5A, 5B, 6A, and 6B illustrate examples of a vehicle setting recommendation being received by a vehicle 110 or 120 or user device 115.

FIGS. 5A and 5B illustrate a vehicle including a vehicle control module and a driver approaching the vehicle. The vehicle control module may be connected to various components and parts of the vehicle, such as the steering wheel and the driver's seat wirelessly or through a wireline connection.

As shown in FIG. 5A, the steering wheel and driver's seat may initially be in one position when no driver is seated in the vehicle. When a driver or the driver's user device 115 is determined or scheduled to be approaching the vehicle, the driver's user device 115 or vehicle may send a message to the network server 130 requesting vehicle setting recommendations. In some implementations, the user device 115 may perform active or passive scanning to detect the presence of a vehicle within a threshold distance of the user device 115. In some implementations, the user device 115 may transmit a beacon signal and receive a response from a vehicle control module of a vehicle in response to the beacon signal. In some implementations, the user device 115 may obtain information from the driver or driver's calendar or personal messages indicating that the driver is scheduled to rent or drive a particular car at a scheduled time.

In some implementations, the request for a vehicle setting recommendation may be sent to the network server 130 automatically when the driver's user device 115 is within a threshold distance of the vehicle. The request may include data indicative of the vehicle make and model and a likely profile of the driver. In response to the message, the recommendation engine 230 may generate and transmit a vehicle setting recommendation to the driver's user device 115.

In the illustrated example, the recommendation engine 230 generates a vehicle setting recommendation for a seat orientation/position based on the likely profile of the driver and transmits the recommendation to the driver's user device 115. Upon receiving the vehicle setting recommendation, the driver's user device 115 may display a message to the driver to inquire whether the driver would like to accept the vehicle setting recommendation. In the illustrated example shown in FIG. 5A, the driver's user device 115 displays a message “WOULD YOU LIKE TO ADJUST THE SEAT POSITION TO POSITION ‘A’ WITH A GREATER INCLINE?”

The driver may then choose to accept, decline, or modify the recommendation. If the driver accepts or modifies the vehicle setting recommendation by making a selection on the driver's user device 115, a signal is sent to the network server 130 and to the vehicle control module to implement the change in vehicle setting according to the vehicle setting values noted in the recommendation or as modified by the driver. For example, as shown in FIG. 5B, when the driver accepts the vehicle setting recommendation to adjust the seat position, an acknowledgement message is displayed on the driver's user device 115, and the car seat position is adjusted in the vehicle by an inclination angle Θ. Although only an adjustment to a car seat has been described, it should be understood that various other vehicle setting values may also be adjusted. For example, in FIG. 5B, the steering wheel may also be adjusted by a distance δ from the dashboard.

As can be appreciated from FIGS. 5A and 5B, in some cases, vehicle setting values may be adjusted when a driver is not present in a car or when a driver is approaching a car.

Referring to FIG. 6A, in some implementations, vehicle setting recommendations may be transmitted directly to a vehicle control module of a vehicle from network server 130. For example, as shown in FIG. 6A, a display unit connected to the vehicle control module in the vehicle displays a message indicative of a recommendation to adjust a mirror position in the vehicle. The driver may choose to accept, decline, or modify the recommendation orally using an integrated vehicle microphone or through a touch input of the display unit.

In another example, the driver may receive a vehicle setting recommendation for a particular type of vehicle setting the driver may not have been aware. For example, as shown in FIG. 6B, if the driver has purchased a sports car and is driving the car with its default factory settings, the driver may be sent a vehicle setting recommendation from network servers 130 recommending the driver to set the vehicle settings to the sports mode. If the driver accepts the recommendation, the vehicle control module may adjust one or more vehicle setting values in the vehicle according to the sports mode vehicle setting.

Embodiments and all of the functional operations and/or actions described in this specification may be implemented in digital electronic circuitry, or in computer software, firmware, or hardware, including the structures disclosed in this specification and their structural equivalents, or in combinations of one or more of them. Embodiments may be implemented as one or more computer program products, e.g., one or more modules of computer program instructions encoded on a computer readable medium for execution by, or to control the operation of, data processing apparatus. The computer-readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program, also known as a program, software, software application, script, or code, may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data in a single file dedicated to the program in question, or in multiple coordinated files. A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

Elements of a computer may include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer may not have such devices. Moreover, a computer may be embedded in another device, e.g., a tablet computer, a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user or driver, embodiments may be implemented on one or more computers having a display device, e.g., a cathode ray tube (CRT), liquid crystal display (LCD), or light emitting diode (LED) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and may even be claimed as such, one or more features from a claimed combination may in some cases be excised from the combination, and the claimed combination may be directed to a sub-combination or variation of a sub-combination.

Similarly, while actions are depicted in the drawings in a particular order, this should not be understood as requiring that such actions be performed in the particular order shown or in sequential order, or that all illustrated actions be performed, to achieve desirable results. Moreover, the separation of various system components in the embodiments described above should not be understood as requiring such separation in all embodiments, and it should be understood that the described program components and systems may generally be integrated together in a single software product or packaged into multiple software products.

Thus, particular implementations have been described. Other implementations are within the scope of the following claims. For example, the actions recited in the claims may be performed in a different order and still achieve desirable results.

What is claimed is:

1. A computer-implemented method comprising:
obtaining driver vehicle setting data from a plurality of vehicles;
identifying a vehicle model associated with the driver vehicle setting data obtained from the plurality of vehicles; and
generating a vehicle setting recommendation for the identified vehicle model based on the driver vehicle setting data obtained from the plurality of vehicles.

2. The computer-implemented method of claim 1, wherein the driver vehicle setting data obtained from the plurality of vehicles includes one or more of mirror positions, a driver seat position, steering wheel position, foot pedal positions, radio station presets, heating, ventilation, air conditioning (HVAC) settings, vehicle lighting preferences, wiper speed settings, navigation settings, camera bumper settings, safety alert settings, child lock settings, and window lock settings.

3. The computer-implemented method of claim 1, wherein the driver vehicle setting data obtained from the plurality of vehicles does not include identification information of a driver.

4. The computer-implemented method of claim 1, wherein generating the vehicle setting recommendation for the identified vehicle model based on the driver vehicle setting data obtained from the plurality of vehicles comprises:
generating the vehicle setting recommendation using machine learning.

5. The computer-implemented method of claim 4, wherein the machine learning comprises training one or more neural networks to determine the vehicle setting recommendation.

6. The computer-implemented method of claim 1, wherein:
obtaining the driver vehicle setting data from the plurality of vehicles comprises receiving crowd-sourced driver vehicle setting data from vehicles having the same model as the identified vehicle model; and
generating the vehicle setting recommendation for the identified vehicle model based on the driver vehicle setting data obtained from the plurality of vehicles comprises:
determining, according to one or more criteria, a score for a vehicle setting;
determining that the score satisfies a particular threshold; and
generating the vehicle setting recommendation to recommend the vehicle setting that has the score that satisfies the particular threshold.

7. The computer-implemented method of claim 6, wherein the one or more criteria includes one or more of:
a frequency of use of the vehicle setting;
a social network trending popularity of the vehicle setting;
a safety rating of the vehicle setting; and
a recommendation from a manufacturer of the identified vehicle model.

8. The computer-implemented method of claim 7, wherein determining, according to one or more criteria, the score for the vehicle setting included in the driver vehicle setting data comprises:
assigning each of the one or more criteria a weight;
determining the score for the vehicle setting based, in part, on the assigned weights to the one or more criteria.

9. The computer-implemented method of claim 1, further comprising:
receiving an indication that a driver is within a threshold distance of a second vehicle;
determining that a model of the second vehicle matches the identified vehicle model; and
transmitting the vehicle setting recommendation to a device associated with the driver within the threshold distance of the second vehicle.

10. The computer-implemented method of claim 9, wherein the device associated with the driver includes a portable electronic device associated with the driver or a vehicle control module of the second vehicle.

11. The computer-implemented method of claim 9, further comprising:
generating a plurality of particular driver profiles; and
determining that a likely profile of the driver within the threshold distance of the second vehicle matches one of the plurality of particular driver profiles.

12. The computer-implemented method of claim 11, wherein determining that the likely profile of the driver within the threshold distance of the second vehicle matches one of the plurality of particular driver profiles comprises:
determining that one or more of a likely height, a likely arm length, and a likely leg length of the driver within the threshold distance of the second vehicle respectively matches one or more of a likely height, a likely arm length, and a likely leg length in the one of the plurality of particular driver profiles, and
wherein the vehicle setting recommendation is based at least in part on the likely profile of the driver.

13. The computer-implemented method of claim 7, further comprising:
receiving an indication that a driver is within a threshold distance of a second vehicle;
determining that a model of the second vehicle matches the identified vehicle model; and
transmitting the vehicle setting recommendation to a device associated with the driver within the threshold distance of the second vehicle,
wherein the one or more criteria includes one or more of an interest of the driver and a vehicle setting preference of the driver, and
wherein the vehicle setting recommendation includes a recommendation associated with the one or more of the interest of the driver and the vehicle setting preference of the driver.

14. The computer-implemented method of claim 9, further comprising:
receiving a selection by the driver indicating acceptance of the vehicle setting recommendation.

15. The computer-implemented method of claim 14, wherein the selection by the driver indicating acceptance of the vehicle setting recommendation is received from a portable electronic device associated with the driver or a vehicle control module of the second vehicle.

16. The computer-implemented method of claim 9, wherein the vehicle setting recommendation includes a recommendation associated with a vehicle setting that has not been activated in the second vehicle.

17. A non-transitory computer-readable storage medium comprising instructions, which, when executed by one or more computers, cause the one or more computers to perform actions comprising:
obtaining driver vehicle setting data from a plurality of vehicles;
identifying a vehicle model associated with the driver vehicle setting data obtained from the plurality of vehicles; and
generating a vehicle setting recommendation for the identified vehicle model based on the driver vehicle setting data obtained from the plurality of vehicles.

18. The non-transitory computer-readable storage medium of claim 17, wherein the actions further comprise:
receiving an indication that a driver is within a threshold distance of a second vehicle;
determining that a model of the second vehicle matches the identified vehicle model; and
transmitting the vehicle setting recommendation to a device associated with the driver within the threshold distance of the second vehicle.

19. A system comprising:
one or more computers and one or more storage devices storing instructions that are operable and when executed by one or more computers, cause the one or more computers to perform actions comprising:
obtaining driver vehicle setting data from a plurality of vehicles;
identifying a vehicle model associated with the driver vehicle setting data obtained from the plurality of vehicles; and
generating a vehicle setting recommendation for the identified vehicle model based on the driver vehicle setting data obtained from the plurality of vehicles.

20. The system of claim 19, wherein the actions further comprise:
receiving an indication that a driver is within a threshold distance of a second vehicle;
determining that a model of the second vehicle matches the identified vehicle model; and
transmitting the vehicle setting recommendation to a device associated with the driver within the threshold distance of the second vehicle.
